(19) United States
(12) Patent Application Publication
(10) Pub. No.: US 2024/0161484 A1
(43) Pub. Date: May 16, 2024

(54) NEURAL IMPLICIT FUNCTION FOR END-TO-END RECONSTRUCTION OF DYNAMIC CRYO-EM STRUCTURES

(71) Applicant: SHANGHAITECH UNIVERSITY, Shanghai (CN)

(72) Inventors: Peihao WANG, Shanghai (CN); Jiakai ZHANG, Shanghai (CN); Xinhang LIU, Shanghai (CN); Zhijie LIU, Shanghai (CN); Jingyi YU, Shanghai (CN)

(73) Assignee: SHANGHAITECH UNIVERSITY, Shanghai (CN)

(21) Appl. No.: 18/418,386

(22) Filed: Jan. 22, 2024

Related U.S. Application Data
(63) Continuation of application No. PCT/CN2021/108512, filed on Jul. 26, 2021.

(51) Int. Cl. G06V 10/82; G06T 7/37

(52) U.S. Cl. CPC G06V 10/82; G06T 7/37; G06T 2207/20084

(57) ABSTRACT

A computer-implemented method is provided. The method includes obtaining a plurality of images representing projections of an object placed in a plurality of poses and a plurality of translations; assigning a pose embedding vector, a flow embedding vector and a contrast transfer function (CTF) embedding vector to each image; encoding, by a computer device, a machine learning model comprising a pose network, a flow network, a density network and a CTF network; training the machine learning model using the plurality of images; and reconstructing a 3D structure of the object based on the trained machine learning module.

### CROSS REFERENCE TO THE RELATED APPLICATIONS

This application is a continuation application of International Application No. PCT/CN2021/108512, filed on Jul. 26, 2021, the entire contents of which are incorporated herein by reference.

### TECHNICAL FIELD

The specification relates generally to the technical field of structural biology and computational technology, and more specifically, to systems of methods for neural implicit function for end-to-end reconstruction of dynamic Cryogenic Electron Microscopy (cryo-EM) structures.

### BACKGROUND

Three-dimensional (3D) atomic-level structure reconstruction of molecules is an essential task in structural biology and drug discovering. Cryogenic Electron Microscopy (cryo-EM) is an electron miscroscopy technique applied on embedded samples in a vitreous water environment and directly captures the images of target proteins without crystallization. Cryo-EM has become a trending facility for biomolecular structure determination. However, reconstructing protein structures from a large set of images is very challenging due to the extremely low signal-to-noise ratio (SNR), unknown particle poses, and non-rigid molecule flexibility and thus requires ingenious algorithm design.

Current software packages like Relion and cryoSPARC have successfully achieved fast and robust performance for high-resolution determination results based on Expectation-Maximization (EM) algorithm. However, these algorithms require an appropriate initialization, which requires manual picking procedures and are prone to error. Moreover, these packages can only reconstruct heterogeneous structures depending on discrete classification, which is at odds with the continuity nature of molecule motions. CryoDRGN regresses a latent distribution of particle deformation using autoencoder neural networks. However, their deformation representation obtained from neural networks is agnostic and implicit. Extracting a complete motion trajectory by manipulating such latent codes is infeasible. Hence, developing a program that has a more automated pipeline and supports heterogeneity reconstruction becomes a promising topic in cryo-EM reconstruction.

### SUMMARY

In view of the aforementioned limitations of existing techniques, this specification presents a computer-implemented method for reconstructing a 3D structure of an object.

The method may include: obtaining a plurality of images representing projections of the object placed in a plurality of poses and a plurality of translations; assigning a pose embedding vector, a flow embedding vector and a Contrast Transfer Function (CTF) embedding vector to each image; and encoding, by a computer device, a machine learning model comprising a pose network, a flow network, a density network and a CTF network.

The pose network may be configured to map an image to a rotation and a translation via the pose embedding vector. The flow network may be configured to concatenate the spatial coordinate with the flow embedding vector, the density network may be configured to derive a density value in accordance with the spatial coordinate and to generate a projection image. The CTF network may be configured to modulate the projection image appended with the CTF embedding vector to generate a rendered image.

The method may further include training the machine learning model using the plurality of images; and reconstructing a 3D structure of the object based on the trained machine learning module.

In some embodiments, the method may further include: simulating the intensity value of a pixel in the projection image by estimating a continuous integral using the quadrature rule.

In some embodiments, the method may further include: partitioning the projection image into a plurality of bins, and selecting a pixel from each of the plurality of bins; and simulating the intensity value of the selected pixel in the projection image by estimating a continuous integral using the quadrature rule.

In some embodiments, the method may further include: partitioning an image into a plurality of patches, and selecting a patch from the plurality of patches; and training the machine learning model using the selected patch.

In some embodiments, the method may further include: training the machine learning model by minimizing the mean-square-error (MSE) loss between rendered images with a ground truth.

In some embodiments, the method may further include: prepending a positional encoding layer to map spatial coordinate to high-frequency representation.

In some embodiments, the pose network may be configured to output a quaternion representation of the rotation and the translation.

In some embodiments, the method may further include: obtaining each of the pose embedding vector, the flow embedding vector and the CTF embedding vector by indexing a dictionary.

In some embodiments, each image may be a cryogenic electron microscopy (cryo-EM) image.

In some embodiments, the object may be a particle dissolved in amorphous ice, and each image may be a micrograph.

In some embodiments, each of the pose network, the flow network and the density network may be a multi-layer perceptron (MLP), and the CTF network may be a convolutional neural network (CNN).

In some embodiments, the multi-layer perceptron (MLP) may be an 8-layer skip-connected MLP of 256 hidden dimensions.

In some embodiments, the method may further include training the machine learning model by applying a penalty on the density value obtained during a current batch.

In some embodiments, the method may further include training the machine learning model by sampling pixels from the image in accordance with an inverse cumulative density function.

In some embodiments, the method may further include: pre-training the CTF network by applying a plurality of CTF parameters to white noise patterns.

### BRIEF DESCRIPTION OF THE DRAWINGS

Various embodiments of the present invention will be described in conjunction with the accompanying drawings.

FIG. 1 shows a pipeline of a computer-implemented method for reconstructing the 3D structure of an object in accordance with one or more embodiments of this invention.

FIG. 2 shows a flowchart of a computer-implemented method for reconstructing the 3D structure of an object in accordance with one or more embodiments of this invention.

FIG. 3 shows a block diagram of a computer system for a computer-implemented method for reconstructing the 3D structure of an object in accordance with various embodiments of the specification.

### DETAILED DESCRIPTION OF THE EMBODIMENTS

Various embodiments of the present invention will be further described in conjunction with the accompanying drawings. It is obvious that the drawings are for exemplary embodiments of the present invention, and that a person of ordinary skill in the art may derive additional drawings without deviating from the principles of the present invention.

### 1. Introduction

A deep-learning-based algorithm for protein structure determination is presented. Modern deep-learning algorithms can robustly and efficiently optimize neural networks to a desirable solution starting from random initialization. By representing the density volume with neural networks, protein structures can be recovered without precise initialization and the time-consuming cycles between particle clustering and ab-initio reconstruction.

Each particle image may be assigned a trainable embedding vector, and neural networks may be adopted to encode these latent codes into particle 6D poses, explicit deformation flows, and Contrast Transfer Functions (CTF). This invention leverages the universal approximation power of deep neural networks that can finetune particle poses, pixel-wise deformation, and CTF more accurately, resulting in higher-resolution structures. A novel cryo-EM structure determination program is elaborated below with reference to accompanying drawings.

### 2. Overview

The aim is to solve the inverse problem of recovering the particle's density volume [symbol] : [symbol] ³→ [symbol] from a set of its projections under some unknown angles (Eqn. 1). Specifically, supposed a cryogenic electron microscopy (cryo-EM) is used to collect a movie of a particle dissolved in amorphous ice, and a set of micrographs (images) [symbol] ={I₁, . . . , I_{N}∈ [symbol] ^{D}^{²}} is picked from this macrograph, where D is the size of micrographs. Each micrograph Iᵢ may contain a projection of the particle placed in an unknown pose Rᵢ∈ [symbol] (3) and tᵢ∈ [symbol] ². Each projection may be modulated by a contrast transfer function CTFᵢ before forming the image.

The entire image formation can be written as below:

Iᵢ(x,y)=CTFᵢ* [symbol] [symbol] (Rᵢr+tᵢ)dz (1)

where * denotes convolution operator, r=(x, y, z)^{T} denotes the spatial position, and the modulation is often formulated as follows:

$${CTF}_{i} ( x , y ) = {ℱ}^{- 1} [ \begin{matrix}{\underbrace{exp \{ j {χ}_{i} ( k ) \}}}_{defocus \& aberration} & {\underbrace{{E}_{s} ( k ) {E}_{t} ( k )}}_{damppingterm}\end{matrix} ] \qquad ( 2 )$$

$${χ}_{i} ( k ) = π ( {\underbrace{0.5 {C}_{s} {λ}^{3} {k}^{4}}}_{sphericalaberration} - {\underbrace{Δ {f}_{i} λ {k}^{2}}}_{defocus} ) \qquad ( 3 )$$

where [symbol] denotes Fourier transform, k=(kₓ, k_{y})^{T} is the spatial frequency, Δƒ is the defocus length, Cₛ is the spherical aberration factor, λ is the wavelength of electron plane wave, and Eₛ, Eₜ are spatial and temporal envelop functions containing high-order terms of frequencies due to beam divergence and energy spread. To recover density volume [symbol] , one needs to optimize it jointly with Rᵢ, tᵢ and CTF₁.

Conventional software utilizing EM algorithm requires a good prior, making the reconstruction procedure cumbersome and time consuming. Besides, traditional algorithms tackle this inverse problem on Fourier domain Despite it gives the closed-form solution, Fourier representation cannot capture molecular dynamics.

To address the limitations of existing techniques, a deep-learning based framework for density estimation from a set of cryo-EM images is presented. The key idea is to parameterize particle poses, density volume, motion flow, and CTF with neural networks, and adopt mini-batch gradient descent approach to optimize each neural representing component end-to-end through the differentiable forward imaging process (Eqn. 1). Since the whole process is modeled on the spatial domain, motion flows may be directly incorporated into the imaging model. In summary, this approach converts the inverse problem of cryo-EM imaging into training implicit neural network parameters to achieve better robustness and full automation.

### 3. Neural Implicit Representation

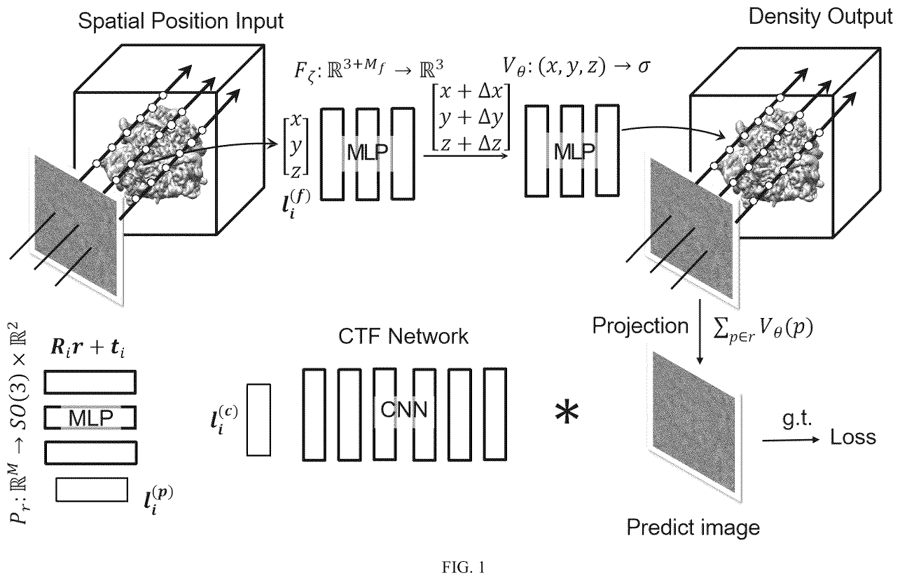

FIG. 1 shows a pipeline of a computer-implemented method for reconstructing the 3D structure of an object in accordance with one or more embodiments of this invention.

As shown in FIG. 1, the pipeline parameterizes density volume, particle poses, motion flow, and CTF with neural networks. Each image is assigned with three embedding vectors for the latent pose, motion and CTF representation. The pose network P_{γ} maps pose embedding into particle affine transformation matrix. The pose matrix casts rays from the observation view and samples points along with outcoming rays. Each point will be added up with the deformation obtained from motion network F_{ζ}. The resultant points will be fed into density network V_{θ} and get the corresponding density. The densities are composed by summation. The projection image will be modulated with a CNN parameterized by a CNN C_{ω}. The rendered image will be finally calculated loss with the captured micrograph. Details of the pipeline are elaborated below.

The first step is to use neural implicit function to represent unknowns (i.e., density, poses, flows, and CTF). Neural implicit function has been widely applied in signal regression, partial derivative equations, and 3D geometry representation. The fully-connected layers are able to approximate arbitrary continuous functions at arbitrary precision. Such deep-learning framework satisfies all of the demand for building a fully end-to-end determination pipeline integrated with flexibility prediction.

To obtain the various functionality of each component, parameterization may be designed for density map, particle poses, molecular motions, and CTF using dedicated neural networks, respectively, details of which are elaborated below.

### 3.1 Density Network

In this invention, a continuous density field is represented as a function [symbol] : [symbol] ³→ [symbol] that maps a spatial coordinate r=(x, y, z)^{T} to density value. This function may be approximated using a neural network V_{θ}: [symbol] ³→ [symbol] parameterized by trained weights θ. A positional encoding layer may be prepended to map coordinates to high-frequency representation. In one example, the adopted neural network may be an 8-layer skip-connected multi-layer perceptron (MLP) of 256 hidden dimensions. The universal approximation theorem guarantees that the density volume can be infinitely approached with an MLP.

### 3.2 Pose Embedding Network

For each particle image Iᵢ, an embedding vector lᵢ^{(p)}∈ [symbol] ^{M}^{ₚ} may be assigned, where Mₚ is the dimension of the embedding space. This embedding can be obtained by either indexing a dictionary or feeding the corresponding image into a convolution-based encoder. These embedding vectors can be learned to encode the distributions of relative particle poses among different images. Then the rotation Rᵢ and translation tᵢ can be regarded as a “projection” from this high-dimension embedding onto their low-dimension representation. Again, this contract mapping may be approximated using an MLP P_{γ}: [symbol] ^{M}^{ₚ}→ [symbol] ⁶ parameterized by weights γ. In practice, P_{γ} may be set to output the quaternion representation qᵢ∈ [symbol] ⁴ of Rᵢ and in-plane translation tᵢ∈ [symbol] ².

### 3.3 Flow Prediction Network

Likewise, for each particle image Iᵢ, an embedding vector lᵢ^{(ƒ)}∈ [symbol] ^{M}^{_{ƒ}} may be assigned, where M_{ƒ} is the embedding dimension. This embedding can be obtained by indexing a dictionary. To obtain point-wise motion flow, the point coordinates may be concatenated with its corresponding flow embedding vector, and fed into another MLP F_{ζ}: [symbol] ^{3+M}^{_{ƒ}}→ [symbol] ³ parameterized by ζ. This MLP can be regarded as a deformation estimator which predicts the motion flow for every point under canonical coordinate conditioned on the image embedding Like our density network V_{θ}, we adopt a positional encoder to map the input coordinates into a high-dimension space.

### 3.4 CTF Network

CTF function may be modeled as a convolutional operator in the literature. In this specification, this operator may be represented by a Convolutional Neural Network (CNN). Compared with the traditional method that fits the explicit CTF in Eq. 2, CNN can be trained to finetune the parameters to approximate a more precise CTF function.

Moreover, CNN can express non-linearity, which enables it to model more complicated aberrations beyond the linearization assumptions. Thereby, a fully convolutional networks C_{ω}: [symbol] ^{D}^{²}→ [symbol] ^{D}^{²} with weights ω is adopted to simulate modulation on each images. Since each micrograph has different defocus due to the non-negligible specimen thickness, each particle image Iᵢ may be assigned an embedding vector Iᵢ^{(c)}∈ [symbol] ^{M}^{_{c}}, where M_{c} is the embedding dimension. Before fed into CNN C_{ω}, each projection may be appended with the corresponding embedding vector.

### 4. Differentiable Imaging

With the neural parameterized components, an imaging process (Eqn. 1) may be represented by the neural networks. Since a fully differentiable forward pass is derived, back-propagation algorithms may be utilized to calculate gradients and optimize each unknowns. The whole pipeline is illustrated in FIG. 1.

The imaging model may contain two stages: at the first stage, the pipeline takes in each pixel position (x, y)^{T}∈[−D/2, D/2]² on the cryo-EM micrograph Iᵢ with the corresponding embedding vector lᵢ^{(p)}, lᵢ^{(θ)}, and lᵢ^{(c)}, and simulate the projection intensity of independent pixel by evaluating the integral along the observation direction:

\hat{q}ᵢ,ŝᵢ,\hat{t}ᵢ=P_{γ}(lᵢ^{(p)}) (4)

\hat{R}ᵢ= [symbol] (\hat{q}ᵢ), \hat{t}ᵢ=\hat{R}ᵢ[ŝᵢ\hat{t}ᵢ0]^{T} (5)

\hat{d}ᵢ(r)=F_{ζ}(\hat{R}ᵢr+\hat{t}ᵢlᵢ^{(ƒ)}) (6)

\hat{M}ᵢ(x,y)= [symbol] V_{θ}(\hat{R}ᵢr+\hat{t}ᵢ+\hat{d}ᵢ(r))dz (7)

where r=(x, y, z)^{T}, and [symbol] (·) converts the quaternion vector to the rotation matrix. It may be assumed that the center of volume is located at the origin and its thickness is D.

At the second stage, the formed image may be modulated by our CTF network C_{ω}:

$${\hat{I}}_{i} = {C}_{ω} ( {\hat{M}}_{i} ; {l}_{i}^{( c )} ) \qquad ( 8 )$$

The integral in Eqn. 7 is intractable to be evaluated. Hereby, the quadrature rule may be used to numerically estimate the continuous integral in Eq. 7. It may be assumed that the center of volume is located at the origin and its thickness is D. Similar to NeRF, a stratified sampling approach may be used when training the networks to recover the density volume. The size of the image [−D/2, D/2] may be partitioned into N evenly-spaced bins. One sample will be drawn uniformly at random within each bin:

$${r}_{j} = {\hat{R}}_{i} [ \begin{matrix}x \\ y \\ {z}_{j}\end{matrix} ] + [ \begin{matrix}{\hat{s}}_{i} \\ {\hat{t}}_{i} \\ 0\end{matrix} ] \qquad ( 9 )$$

$${p}_{j} = {r}_{j} + {\hat{d}}_{i} ( {r}_{i} ) \qquad ( 10 )$$

$${z}_{j} \sim 𝒰 [ - \frac{D}{2} + \frac{( j - 1 ) D}{N} , - \frac{D}{2} + \frac{jD}{N} ] \qquad ( 11 )$$

The numerical integral can be formulated as below:

$${\hat{M}}_{i} ( x , y ) {\sum }_{j = 1}^{N} \frac{{V}_{θ} ( {p}_{j} ) + {V}_{θ} ( {p}_{j - 1} )}{2} {‖ {p}_{j} - {p}_{j - 1} ‖}_{2} , \qquad ( 12 )$$

During the inference stage, the sampled points may be fixed on the volume lattice

$${z}_{j} = - \frac{D}{2} + \frac{jD}{N} ,$$

and the density volume may be exported by querying these sample points V_{θ}(x, y, zⱼ).

### 5. Optimization

Combining Eqn. 4-12, a differentiable forward model may be derived. The captured images may be used to supervise the density network V_{θ} jointly with the particle embeddings {lᵢ^{(p)}, lᵢ^{(ƒ)}, lᵢ^{(c)}}_{i=1, . . . ,N}, pose mapping network P_{γ}, motion flow network F_{ζ}, and the CTF network C_{ω}.

Instead of using an entire D×D image to supervise our networks, all micrographs may first be split into small patches to save the computational complexity. At each optimization step, a batch of m patches {Iᵢ_{ₖ}}ₖ₌₁^{m}⊂ [symbol] may be picked with their index iₖ's. In one embodiment, all the patches from all images are randomly picked to form a batch, and the picked patches do not necessarily have the same position within its image.

The corresponding embedding vectors {lᵢ^{(p)}, lᵢ^{(ƒ)}, lᵢ^{(c)}}ₖ₌₁^{m} may be obtained by querying a dictionary with their index values. Then, the images with their embeddings may be fed into the rendering model Eqn. 4-8, and the generated images {Îᵢ_{ₖ}}ₖ₌₁^{m} may be obtained. The mean-square-error (MSE) loss between {Iᵢ_{ₖ}}ₖ₌₁^{m} and ground truth {Îᵢ_{ₖ}}ₖ₌₁^{m} may be minimized. That is, the loss function [symbol] may be:

[symbol]

=Σₖ₋₁^{m}∥Iᵢ_{ₖ}−Îᵢ_{ₖ}∥₂². (13)

The following supervision and training procedures may be provided to produce more accurate results.

### 5.1 Volume Density Prior

The neural implicit volume may be optimized to have a low total energy, i.e., [symbol] F_{θ}(x)dx. To reduce the query number on V_{θ}, a penalty may be applied on the density values obtained during training the current batch:

[symbol]

ₚᵣᵢₒᵣ= [symbol] V_{θ}(pⱼ), (14)

where [symbol] denotes the set of points sampled during imaging {Îᵢ_{ₖ}}ₖ₌₁^{m}. During training, a batch of image patches from the training set will be sampled, and the density values will be calculated. The calculated density values will be used to generate a projection image to make a loss with the groundtruth. To avoid recomputing, the density values calculated for this batch is saved before the projection, and a penalty is applied on the calculated density value after the projection to regularize it. The penalty applied is equal to regularization.

Finally, the total loss function may be expressed as:

[symbol]

ₜₒₜₐₗ= [symbol] +λ₀ [symbol] ₚᵣᵢₒᵣ, (15)

where λ₀ denotes the weight for regularization. In practice, we find λ₀=0.1 attains the best performance.

### 5.2 Importance Sampling

During the training stage, the importance sampling may be applied when evaluating Eqn. 7. The sampling distribution may follow from the inverse cumulative density function of V_{θ}. Specifically, the absolute value of density along each ray is normalized. Thus, each ray can be regarded to have a PDF. Then, the second set of points can be obtained by inverse transform sampling algorithm according to the PDF. These new points will be merged with the previously sampled points to evaluate a more accurate integral. This strategy improves the precision of the quadrature integral, and thus results in higher resolution structures.

### 5.3 Pre-Training CTF Network

In general, CTF only means a narrow class of functions. Training a simple CNN to fit the exact CTF from random initialization can be infeasible. Therefore, the CTF network C_{ω} may be pre-trained to approximate a prior CTF computed by conventional algorithms. A common CTF-find program may first be run to obtain a group of conventional CTF parameters. Then the ground truth responses may be synthesized by applying this computed CTF to white noise patterns. These pairs may be used to train the CTF network C_{ω} to approximate the computed CTF. Afterwards, the CTF networks with other components may be jointly trained through the image supervision.

### 6. Reconstructing the 3D Structure of an Object

Based on the above description, a computer-implemented method for reconstructing the 3D structure of an object is described below.

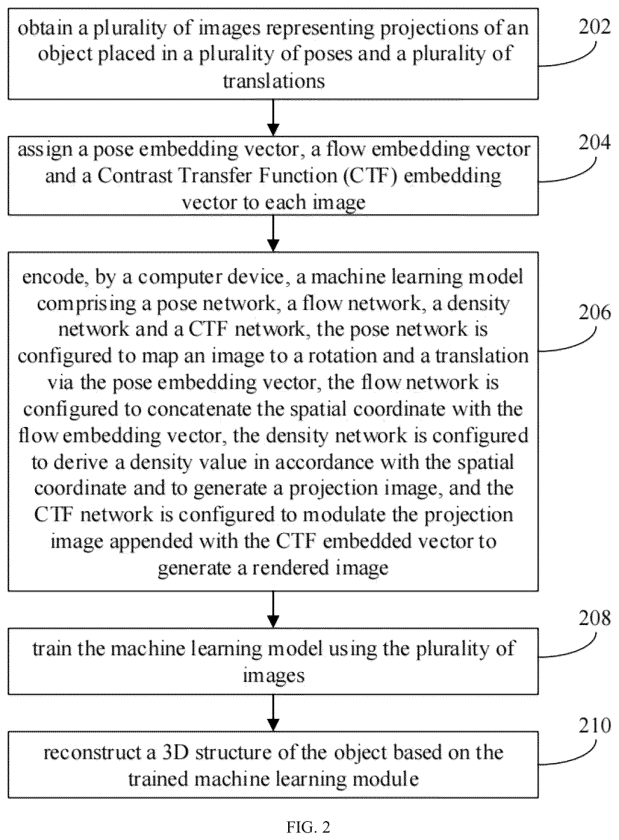

FIG. 2 shows a flowchart of a computer-implemented method for reconstructing the 3D structure of an object in accordance with one or more embodiments of this invention. This method will be described below with reference to FIG. 2.

As shown in FIG. 2, the computer-implemented method 200 for reconstructing the 3D structure of an object may include the following steps S202 through S210.

In step S202, a plurality of images representing projections of an object placed in a plurality of poses and a plurality of translations may be obtained.

In step S204, a pose embedding vector, a flow embedding vector and a Contrast Transfer Function (CTF) embedding vector may be assigned to each image.

In step S206, a machine learning model comprising a pose network, a flow network, a density network and a CTF network may be encoded by a computer device.

The pose network may be configured to map an image to a rotation and a translation via the pose embedding vector. The flow network may be configured to concatenate the spatial coordinate with the flow embedding vector. The density network may be configured to derive a density value in accordance with the spatial coordinate and to generate a projection image. The projection image may be generated in accordance with any pose or direction. The CTF network may be configured to modulate the projection image appended with the CTF embedding vector to generate a rendered image.

In step S208, the machine learning model may be trained using the plurality of images.

In step S210, a 3D structure of the object may be reconstructed based on the trained machine learning module.

In some embodiments, the method may further include: simulating the intensity value of a pixel in the projection image by estimating a continuous integral using the quadrature rule.

In some embodiments, the method may further include: partitioning the projection image into a plurality of bins, and selecting a pixel from each of the plurality of bins; and simulating the intensity value of the selected pixel in the projection image by estimating a continuous integral using the quadrature rule.

In some embodiments, the method may further include: partitioning an image into a plurality of patches, and selecting a patch from the plurality of patches; and training the machine learning model using the selected patch.

In some embodiments, the method may further include training the machine learning model by minimizing the mean-square-error (MSE) loss between rendered images with a ground truth.

In some embodiments, the method may further include: prepending a positional encoding layer to map spatial coordinate to high-frequency representation.

In some embodiments, the pose network may be configured to output a quaternion representation of the rotation and the translation.

In some embodiments, the method may further include: obtaining each of the pose embedding vector, the flow embedding vector and the CTF embedding vector by indexing a dictionary.

In some embodiments, each image may be a cryogenic electron microscopy (cryo-EM) image.

In some embodiments, the object may be a particle dissolved in amorphous ice, and each image may be a micrograph.

In some embodiments, each of the pose network, the flow network and the density network may be a multi-layer perceptron (MLP), and the CTF network may be a convolutional neural network (CNN).

In some embodiments, the multi-layer perceptron (MLP) may be an 8-layer skip-connected MLP of 256 hidden dimensions.

In some embodiments, the method may further include training the machine learning model by applying a penalty on the density value obtained during a current batch.

In some embodiments, the method may further include training the machine learning model by sampling pixels from the image in accordance with an inverse cumulative density function.

In some embodiments, the method may further include: pre-training the CTF network by applying a plurality of CTF parameters to white noise patterns.

This specification further presents a computer system for implementing the method for reconstructing the 3D structure of an object, in accordance with various embodiments of this specification.

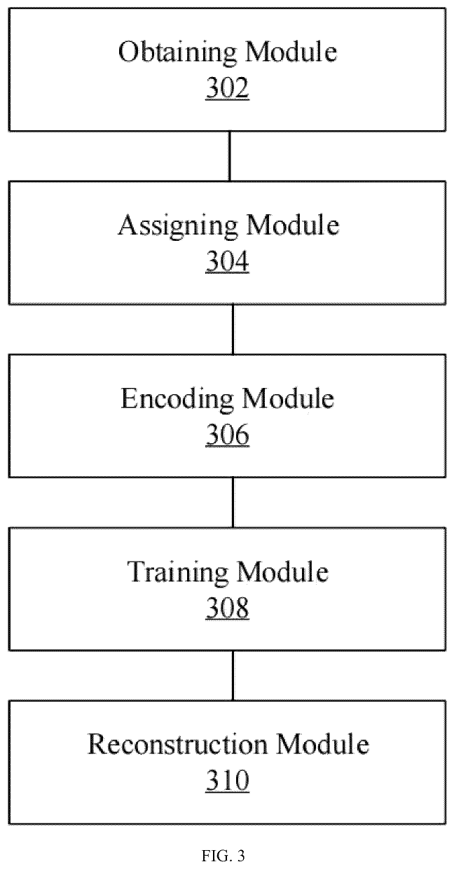

FIG. 3 shows a block diagram of a computer system for a computer-implemented method for reconstructing the 3D structure of an object in accordance with various embodiments of the specification. As shown in FIG. 3, the system 300 may be an exemplary implementation of the method 200 of FIG. 2 or one or more devices performing the method 200.

The computer system 300 may include one or more processors and one or more non-transitory computer-readable storage media (e.g., one or more memories) coupled to the one or more processors and configured with instructions executable by the one or more processors to cause the system or device (e.g., the processor) to perform the method 200.

The computer system 300 may include various units/modules corresponding to the instructions (e.g., software instructions). In some embodiments, the computer system 300 may include an obtaining module 302, an assigning module 304, an encoding module 306, a training module 308, and a reconstruction module 310.

The obtaining module 302 may be configured to obtain a plurality of images representing projections of an object placed in a plurality of poses and a plurality of translations.

The assigning module 304 may be configured to assign a pose embedding vector, a flow embedding vector and a Contrast Transfer Function (CTF) embedding vector to each image.

The encoding module 306 may be configured to encode a machine learning model comprising a pose network, a flow network, a density network and a CTF network.

The pose network may be configured to map an image to a rotation and a translation via the pose embedding vector, the flow network is configured to concatenate the spatial coordinate with the flow embedding vector. The density network may be configured to derive a density value in accordance with the spatial coordinate and to generate a projection image. The CTF network may be configured to modulate the projection image appended with the CTF embedding vector to generate a rendered image.

The training module 308 may be configured to train the machine learning model using the plurality of images.

The reconstruction module 310 may be configured to reconstruct a 3D structure of the object based on the trained machine learning module. Certain embodiments are described herein as including logic or a number of components. Components may constitute either software components (e.g., code embodied on a machine-readable medium) or hardware components (e.g., a tangible unit capable of performing certain operations which may be configured or arranged in a certain physical manner).

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

What is claimed is:

1. A computer-implemented method comprising:
obtaining a plurality of images representing projections of an object placed in a plurality of poses and a plurality of translations;
assigning a pose embedding vector, a flow embedding vector, and a Contrast Transfer Function (CTF) embedding vector to each of the plurality of images;
encoding, by a computer device, a machine learning model comprising a pose network, a flow network, a density network, and a CTF network, wherein the pose network is configured to map an image to a rotation and a translation via the pose embedding vector, the flow network is configured to concatenate a spatial coordinate with the flow embedding vector, the density network is configured to derive a density value in accordance with the spatial coordinate and to generate a projection image, and the CTF network is configured to modulate the projection image appended with the CTF embedding vector to generate a rendered image;
training the machine learning model using the plurality of images; and
reconstructing a 3D structure of the object based on a trained machine learning module.

2. The computer-implemented method of claim 1, further comprising:
simulating an intensity value of a pixel in the projection image by estimating a continuous integral using a quadrature rule.

3. The computer-implemented method of claim 1, further comprising:
partitioning the projection image into a plurality of bins, and selecting a pixel from each of the plurality of bins; and
simulating an intensity value of a selected pixel in the projection image by estimating a continuous integral using a quadrature rule.

4. The computer-implemented method of claim 2, further comprising:
partitioning the projection image into a plurality of patches, and selecting a patch from the plurality of patches; and
training the machine learning model using a selected patch.

5. The computer-implemented method of claim 2, further comprising:
training the machine learning model by minimizing a mean-square-error (MSE) loss between rendered images with a ground truth.

6. The computer-implemented method of claim 1, further comprising:
prepending a positional encoding layer to map the spatial coordinate to a high-frequency representation.

7. The computer-implemented method of claim 1, wherein the pose network is configured to output a quaternion representation of the rotation and the translation.

8. The computer-implemented method of claim 1, further comprising:
obtaining each of the pose embedding vector, the flow embedding vector, and the CTF embedding vector by indexing a dictionary.

9. The computer-implemented method of claim 1, wherein each of the plurality of images is a cryogenic electron microscopy (cryo-EM) image.

10. The computer-implemented method of claim 2, wherein the object is a particle dissolved in an amorphous ice, and each of the plurality of images is a micrograph.

11. The computer-implemented method of claim 1, wherein each of the pose network, the flow network, and the density network is a multi-layer perceptron (MLP), and the CTF network is a convolutional neural network (CNN).

12. The computer-implemented method of claim 11, wherein the MLP is an 8-layer skip-connected MLP of 256 hidden dimensions.

13. The computer-implemented method of claim 1, further comprising:
training the machine learning model by applying a penalty on the density value obtained during a current batch.

14. The computer-implemented method of claim 1, further comprising:
training the machine learning model by sampling pixels from the image in accordance with an inverse cumulative density function.

15. The computer-implemented method of claim 1, further comprising:
pre-training the CTF network by applying a plurality of CTF parameters to white noise patterns.
